(19) United States
(12) Patent Application Publication
(10) Pub. No.: US 2010/0054077 A1
(43) Pub. Date: Mar. 4, 2010

(54) METHOD AND APPARATUS FOR DETERMINING THE HOMOGENEITY OF A MIXTURE

(76) Inventors: Tomas Qvarfort, Rauenberg (DE); Thomas Schneider, Sandhausen (DE)

Correspondence Address: COLLARD & ROE, P.C., 1077 NORTHERN BOULEVARD, ROSLYN, NY, 11576, US

(21) Appl. No.: 12/312,339

(22) PCT Filed: Oct. 8, 2007
(86) PCT No.: PCT/DE2007/001787

§ 371 Date: Oct. 30, 2009

(30) Foreign Application Priority Data
Nov. 7, 2006 (DE) 10 2006 052 672.4

(51) Int. Cl. G01N 21/85; B01F 15/00; G01N 21/35; G01J 3/28; G01J 3/00

(52) U.S. Cl. 366/142; 356/326; 356/51

(57) ABSTRACT

Method and apparatus for determining the homogeneity (3) of a mixture. Known mixing methods require multiple calibration passes in order to automatically determine the end point of a mixing operation. This signifies a high level of complexity in the case of continuously changing products. The object of the present invention is to make it possible to automatically determine the end point of a mixing operation without having to carry out calibration passes. This is achieved by creating continuous spectral analyses of the mixture. As soon as the variance is under a tolerance (8) over a predefinable amount of time, the mixture is deemed to be homogeneous. The invention also relates to the determination of the end point of a mixing operation and to substance classification.

The invention relates to a method and an apparatus for determining the homogeneity of a mixture.

Within the scope of industrial mixing methods, whether for the production of plastics, of foods, or of medications, increasingly greater demands are being made with regard to the quality of the products to be produced. Mixtures must be measured precisely, to details, and must be blended completely, before they are allowed to be passed on to a customer. A relatively easily comprehensible example in this connection is the production of instant soups, in which the use of an ingredient in too great an amount can mean a significant change in taste. Poor blending of such a product can also lead to this result, for example if an overly large proportion of salt is added to one sales unit, and correspondingly missing in another sales unit, as the result of poor blending.

This can be critical in the composition of medications, in which the addition of an active substance to a medication can cause a harmful effect instead of a healing effect if a limit of this active substance is exceeded. In the final analysis, the quality of a product cannot be guaranteed if the composition and blending are unreliable.

For this reason, the industry is increasingly switching over to automating the processes of combining and mixing, as well as quality control. On the basis of spectral analyses that are carried out using near infrared spectrometers (NIR spectrometers), for example, it is possible to rapidly and precisely determine the composition of a mixture. This is brought about, in conventional manner, in that first, a reference product is recorded, using the spectrometer, and a model spectrum is drawn up in this manner, with which the product to be mixed is compared in the later industrial method. In order to be able to take possible deviations from a precise model spectrum into consideration, multiple passes of such reference measurements are usually carried out, in some cases up to 30 reference measurements for each product. This represents an enormous effort, but without it, a reliable determination of the product cannot take place according to conventional methods.

In the same manner, conventional methods are used to determine whether or not homogeneity of the mixture has already occurred, namely in that a required proportion of predetermined substances is determined on the basis of reference measurements. The required blending has been achieved if the proportion of these substances reaches the reference value, in each instance, in a number of measurements carried out continuously. This, however, opens up new problems again, if a change in the formulation leads to a different concentration of the stated substance. If, for some reason, this special ingredient is not supposed to be added when the formulation for the mixture to be produced is being prepared, homogeneity is fundamentally not achieved. For this reason, an end point of the blending process cannot be determined.

Against this background, the present invention is based on the task of creating a method and an apparatus for determining the homogeneity of a mixture composed of at least two substances, or possibly of one substance at different grain sizes, which make prior reference measurements for classification of the mixed products unnecessary, and which can determine the degree of homogeneity of a mixture independent of its composition.

This task is accomplished by means of a method according to the characteristics of the main claim, as well as an apparatus according to the characteristics of the secondary claim 11. Other practical embodiments of the method and of the apparatus, respectively, can be derived from the dependent claims, in each instance.

According to the invention, the homogeneity of a mixture composed of at least two substances, or possibly of one substance at different grain sizes, is determined in that a plurality of snapshots of the spectrum of the mixture is created over the course of blending, preferably using an NIR spectrometer. The individual snapshots of the spectrum are compared with one another, and the variation of the spectral curve over time is recorded. As soon as the variation of the spectrum over time goes below a limit value, which corresponds to exceeding a limit value of homogeneity, the mixture is considered to be homogeneous. This brings the advantage that the homogeneity of the substance present at any particular time can be determined independent of the composition of the mixture. As a result, possible prior reference measurements are eliminated; these would be cost-intensive and time-intensive to repeat, particularly if changes were made in the product to be produced. Also, the problem that an end point of the mixing process could not be recognized if a specific substance was not added, because it was forgotten or for some other reason is eliminated. In this manner, the process becomes not only simpler, but also more cost-effective and reliable.

During the course of a blending process, it can certainly occur that the mixture would have to be considered homogeneous within a certain period of time. Such homogeneity between several snapshots of the spectrum carried out one after the other can be produced very easily in that the stated snapshots are made at very short intervals, one after the other, so that a change does not take place during the intermediate time selected, which is too short. Consequently, it appears practical to consider a mixture homogeneous only once the variation in the spectrum moves within a tolerance range for an entire observation period. In this manner, the situation is prevented that the impression of homogeneity is produced within the mixing process, as the result of random processes, while in fact complete homogeneity does not yet exist.

Specifically the fact that non-uniform intermediate results can occur during the mixing process furthermore makes it practical to continuously repeat the snapshots of the spectrum.

As soon as it has been possible to determine the homogeneity of a mixture, in the manner prescribed, a next step follows, in which the mixture, which is now homogeneous, is classified on the basis of model spectra that were previously stored in memory. For this purpose, the stated model spectra are compared with the spectrum of the mixture at its end point, in other words in the homogeneous state, and, in case of agreement of the mixture with one of the model spectra, the mixture is classified in accordance with the model spectrum in question. If agreement with a model spectrum cannot be determined, on the other hand, it is possible to store the spectrum, which has consequently not yet been classified, in memory as a new model spectrum, and thus to enter a new product definition into the system.

In order to be able to obtain a comparable progression of every mixing process, it has proven to be practical to record the beginning of a mixing process in such a manner that the spectral analysis begins synchronously with the mixing process. In this connection, the beginning of the mixing process is recorded automatically, whereupon the spectral analysis is started. Analogously, after a tolerance limit of the degree of homogeneity has been exceeded, and, at the same time, the recorded spectrum agrees with one of the model spectra, the mixing process is ended automatically, whereby here, it is also advantageous if synchronization takes place.

In an individual case, of course, it can also happen that a mixing process does not lead to a homogeneous substance, thus an end point is not reached even according to this improved method. In this case, a maximum duration is provided, after which the mixing process is stopped in any case, if neither the desired homogeneity occurs during this time, nor agreement with a model spectrum is achieved.

Depending on the desired accuracy, it is advantageous that any changeable general condition, for example the tolerance range of homogeneity, the length of the observation period, and/or the maximum duration of the mixing process, are predetermined in changeable manner. For example, in the foods sector, a lower homogeneity of the product is tolerable than in the sector of pharmacy.

An apparatus according to the invention, for determining the homogeneity of a mixture composed of at least two substances, or possibly of one substance at different grain sizes, is produced from a controllable mixing unit, a spectrometer, preferably an NIR spectrometer, as well as a data processing device. The data processing device controls the entire mixing process, whereby after the beginning of the mixing process, as the result of starting the controllable mixing unit, the spectral analysis is also started. The data resulting from the spectral analysis are passed to the data processing device, and the comparison with the model spectra present in a database, as well as a decision concerning the fact that the determined spectrum and model spectrum are the same, are carried out. For the remainder, the data processing device demonstrates the conventional properties and capabilities of a control system.

In advantageous manner, samples can be taken from the apparatus for further analysis, so that if necessary, the results of the apparatus can be checked manually, or a result that has not been defined or classified up to that time can be passed to further analyses.

The invention described above will be explained in greater detail in the following, using an exemplary embodiment shown schematically in the drawing.

This shows:

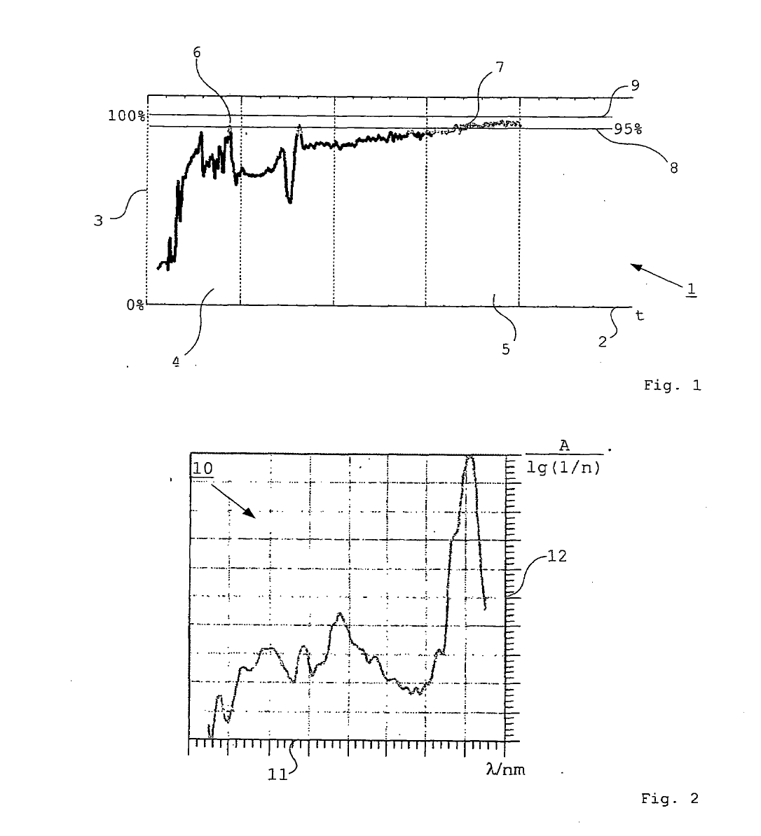

FIG. 1 a chart of the homogeneity over the course of a mixing process, whereby the degree of homogeneity is plotted over time, and

FIG. 2 a snapshot of a spectrum within the scope of a mixing process, whereby the proportions are plotted over the reflection frequency.

FIG. 1 shows a possible progression of the homogeneity of a mixture, considered over the mixing period. The chart lies in a coordinate system, in which the time axis 2 is plotted as the crosswise axis, the degree of homogeneity 3 is plotted as the upright axis. The mixing process is started synchronous to the beginning of a spectral analysis, in a first time window 4, then runs past two other times windows, all the way to a fourth time window 5, within which homogeneity of the mixture has been achieved. The spectral analysis on which the determination of homogeneity of the mixture is based is carried out using a near infrared spectrometer (NIR spectrometer), and analyzed using a data processing device. The data processing device furthermore controls a mixing unit with which blending of the substances to be mixed, or of the different grain sizes to be mixed, is achieved.

At first, the degree of homogeneity of the mixture in the first time window is very low, because blending of the substances or grain sizes to be mixed is very slight, at first. The homogeneity increases greatly as the result of continuous mixing, actually reaches a tolerance range of homogeneity within the first time window 4, for a short homogeneity phase 6, which is the aim of the mixing process. This tolerance range lies above a tolerance limit 8 that typically lies at about 95%; however, during the course of mixing, the homogeneity goes below this value again, after a short period of time. In a second time window, too, this tolerance limit 8 is briefly not reached, but continuing improvement of the homogeneity occurs, so that the mixing process is not yet stopped at this point only in the fourth time window 5 does the homogeneity continuously rise into the tolerance range between tolerance limit 8 and upper homogeneity limit 9, the latter representing a homogeneity of 100%. Only in this fourth time window 5 does the homogeneity remain in the tolerance range for a sufficient observation period, without deviating from it negatively again. Consequently, the system now considers the mixture to be homogeneous.

Mathematically, the homogeneity is calculated as described in the following. The spectrum X_{(t,m)} can be determined by means of

X_{(t,m)}=T_{(t,n)}·P_{(u,m)}+E_{(t,m)}

where T is the inherent values of the line descriptions and P is the inherent vectors of the column descriptions. The value E is a remainder, which can also become zero, in a special case. The homogeneity Hₜ then results from

$${H}_{t} = \frac{1}{1 + {\sum }_{i = 1}^{n} {T}_{( t , i )}^{2}}$$

where the inherent values of the line descriptions are dependent on the time t.

FIG. 2 shows a possible spectrum 10 as a snapshot of a composition of the mixture to be considered. The chart shows the proportion 12 of the light wavelengths, in each instance, that are reflected by the ingredients of the mixture, on the upright axis, above the reflected light wavelengths 11 as the longitudinal axis. This spectrum 10 is continuously recorded by the spectrometer in the arrangement according to the invention. The spectrum 10 changes over time, in other words over the mixing period, as a function of the substance that can be recorded by the spectrometer, at that particular moment. The variance in the spectrum is recorded by the data processing device and converted to the homogeneity progression considered above in FIG. 1. In this connection, a very great variance corresponds to very slight homogeneity, and vice versa, a variance of almost zero corresponds to a homogeneity of almost 100%.

At the same time with the determination of the variance of a chart, this chart is already compared with model spectra stored in the memory of the data processing device, thereby undertaking a classification of the mixture. If the mixture corresponds to a model spectrum during an observation period of the mixing process, or corresponds to it even after having reached homogeneity, the mixture is classified in accordance with the model spectrum found by means of the comparison.

A method and an apparatus for determining the homogeneity of a mixture composed of at least two substances, or possibly of one substance at different grain sizes, are therefore described above, according to which a determination of homogeneity without prior reference measurements is possible because the spectrum of the mixture is continuously recorded, and the degree of homogeneity is determined on the basis of the variance of the spectrum. Also, a comparison with mixtures that are already known is made using model spectra, thereby making classification of the mixture currently being produced possible.

### REFERENCE SYMBOL LIST

1 homogeneity progression
2 time axis
3 degree of homogeneity
4 first time window
5 fourth time window
6 short homogeneity phase
7 homogeneity range
8 tolerance limit
9 upper limit of homogeneity
10 spectrum
11 reflected light wavelength
12 proportion

1. Method for determining the homogeneity of a mixture composed of at least two substances, or possibly of one substance at different grain sizes, wherein a plurality of snapshots of the spectrum (10) of the mixture is created by means of a spectrometer, and the change is determined with reference to at least one prior snapshot, but without accessing prior reference measurements, and a degree of homogeneity is determined on the basis of the variation of the spectrum (10), whereby a mixture is considered to be homogeneous if the variation of the spectrum (10) runs exclusively within a tolerance range over an observation time period (4, 5).

2. (canceled)

3. Method according to claim 1, wherein the snapshots of the spectrum (10) of the mixture are created continuously.

4. Method according to claim 1, wherein after homogeneity in the tolerance range has been reached, the spectrum (10) of the mixture that has been determined is compared, preferably automatically, with model spectra previously stored in memory, and, in the case of agreement, the mixture is classified according to the model spectrum that agrees with it.

5. Method according to claim 1, wherein in the case of non-agreement of the spectrum (10) of the mixture with model spectra previously stored in memory, inclusion of the spectrum (10) as a model spectrum is made possible.

6. Method according to claim 1, wherein the spectrum (10) is produced by way of a near infrared spectral analysis.

7. Method according to claim 1, wherein the beginning of a mixing process is recorded automatically, whereby the spectral analysis begins at least almost synchronous with the mixing process.

8. Method according to claim 1, wherein after a tolerance limit (8) of the degree of homogeneity (3) has been exceeded, and at simultaneous agreement with one of the model spectra, mixing is automatically ended, whereby the spectral analysis ends at least almost synchronous with the mixing process.

9. Method according to claim 1, wherein the mixing process is stopped after a maximum duration, within which the tolerance limit (8) of the degree of homogeneity is not exceeded, and/or no agreement with a model spectrum is achieved.

10. Method according to claim 1, wherein general conditions, such as the tolerance range (8, 9) of homogeneity, the length of the observation period (4, 5), and/or the maximum duration can be predetermined.

11. Apparatus for determining the homogeneity of a mixture composed of at least two substances, or possibly of one substance at different grain sizes, comprising a controllable mixing unit for blending the substances, a spectrometer for creating a plurality of snapshots of the spectrum (10) of the mixture, as well as a data processing device for determining changes in the mixture with reference to at least one prior snapshot, and for determining a degree of homogeneity of the mixture on the basis of the variation in the spectrum (10), and for controlling the mixing unit.

12. Apparatus according to claim 11, wherein a near infrared spectrometer (NIR spectrometer) is used as a spectrometer.

13. Apparatus according to claim 11, wherein samples can be taken from the mixture, preferably automatically, for further analysis.

14. Apparatus according to claim 11, wherein an evaluation of the spectra (10) determined can be carried out automatically, using the data processing device.
